(19) United States
(12) Patent Application Publication
(10) Pub. No.: US 2021/0215813 A1
(43) Pub. Date: Jul. 15, 2021

(54) RADAR DEVICE

(71) Applicant: MING-TSUNG CHEN, Taipei City (TW)

(72) Inventor: MING-TSUNG CHEN, Taipei City (TW)

(21) Appl. No.: 16/738,761

(22) Filed: Jan. 9, 2020

(51) Int. Cl. G01S 13/04; G01S 7/03; G01S 7/00

(52) U.S. Cl. CPC G01S 13/04; G01S 2007/027; G01S 7/006; G01S 7/03

(57) ABSTRACT

A radar device includes a control module, a first directional antenna module, a second directional antenna module, a third directional antenna module, and a fourth directional antenna module. The control module is disposed on a circuit board. The control module includes a first communication unit and a second communication unit. The first communication unit is electrically connected to the second communication unit. The first communication unit transmits a plurality of first communication signals to the second communication unit. The second communication unit converts the first communication signals into second communication signals. The control module the first directional antenna module, the second directional antenna module, the third directional antenna module, and the fourth directional antenna module are vertically arranged on the circuit board.

### FIELD OF THE DISCLOSURE

The present disclosure relates to a radar device, and more particularly to a radar device using Bluetooth® communication signals.

### BACKGROUND OF THE DISCLOSURE

In general, a radar device uses microwave, laser, or sonar to detect whether objects have appeared within a predetermined range; however, the cost involved therewith cannot be reduced.

Therefore, providing a low-cost radar device has become an important issue in the industry.

### SUMMARY OF THE DISCLOSURE

In response to the above-referenced technical inadequacies, the present disclosure provides a radar device. The radar device includes a control module, a first directional antenna module, a second directional antenna module, a third directional antenna module, and a fourth directional antenna module. The control module is disposed on a circuit board. The control module includes a first communication unit and a second communication unit. The first communication unit is electrically connected to the second communication unit. The first communication unit transmits a plurality of first communication signals to the second communication unit. The second communication unit converts the first communication signals into second communication signals. The first directional antenna module is electrically connected to the first communication unit. The first directional antenna module is disposed at a first side of the control module. The second directional antenna module is electrically connected to the first communication unit. The second directional antenna module is disposed at a second side of the control module. The second side of the control module is adjacent to the first side of the control module. The third directional antenna module is electrically connected to the first communication unit. The third directional antenna module is disposed at a third side of the control module. The third side of the control module is opposite to the first side of the control module. The fourth directional antenna module is electrically connected to the first communication unit. The fourth directional antenna module is disposed at a fourth side of the control module. The fourth side of the control module is opposite to the second side of the control module. The first directional antenna module, the second directional antenna module, the third directional antenna module, and the fourth directional antenna module are vertically arranged on the circuit board.

Therefore, the radar device of the present disclosure uses only multiple directional antenna modules to transmit communication signals for detecting whether a person or a moving object is present in a predetermined area so as to control electronic devices and lighting devices.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a radar device of an embodiment of the present disclosure.

FIG. 2 is a functional block diagram of the radar device of the embodiment of the present disclosure.

FIG. 3 is an exploded view of the radar device of the embodiment of the present disclosure.

FIG. 4 is a schematic view of a top case unit and a bottom case unit of the radar device of the embodiment of the present disclosure.

FIG. 5 is a schematic view of a first directional antenna of the radar device of the embodiment of the present disclosure.

FIG. 6 is a schematic view showing the radar device of the present disclosure being disposed in a predetermined area.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

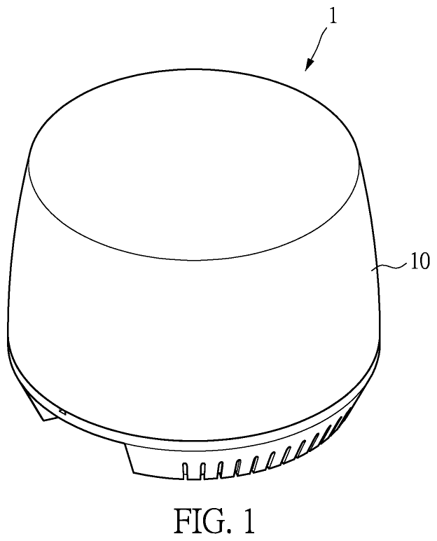

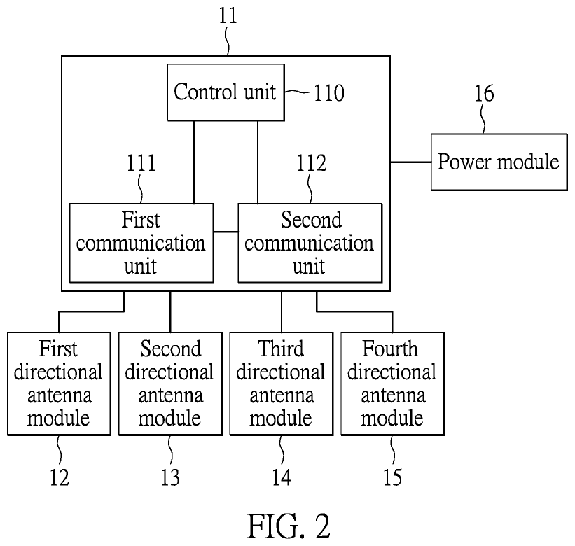

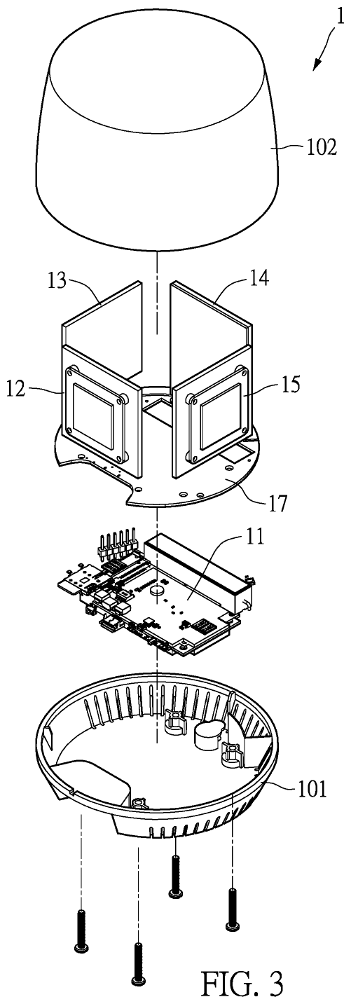

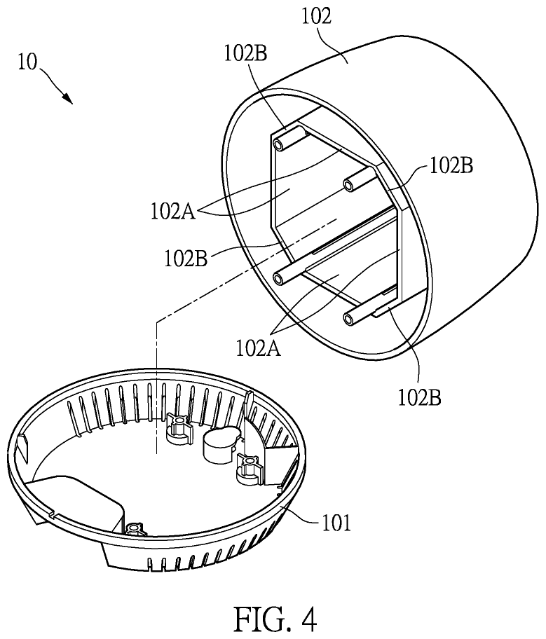

Referring to FIG. 1, FIG. 2, FIG. 3 and FIG. 4, FIG. 1 is a perspective view of a radar device of an embodiment of the present disclosure. FIG. 2 is a functional block diagram of the radar device of the embodiment of the present disclosure. FIG. 3 is an exploded view of the radar device of the embodiment of the present disclosure. FIG. 4 is a schematic view of a top case unit and a bottom case unit of the radar device of the embodiment of the present disclosure.

A radar device 1 includes a case 10, a control module 11, a first directional antenna module 12, a second directional antenna module 13, a third directional antenna module 14, a fourth directional antenna module 15, a power module 16, and a circuit board 17.

The control module 11, the first directional antenna module 12, the second directional antenna module 13, the third directional antenna module 14, the fourth directional antenna module 15, the power module 16, and the circuit board 17 are disposed in the case 10.

The control module 11 is disposed on the circuit board 17. The control module 11 includes a control unit 110, a first communication unit 111, and a second communication unit 112. The control unit 110 is electrically connected to the first communication unit 111 and the second communication unit 112. The first communication unit 111 is electrically connected to the second communication unit 112. In the embodiment, the first communication unit 111 transmits a plurality of first communication signals to the second communication unit 112. The second communication unit 112 converts the first communication signals into a plurality of second communication signals. The second communication unit 112 is electrically connected to a communication antenna (not shown) to transmit or receive a plurality of the second communication signals. Similarly, the second communication unit 112 may receive the second communication signals and transmit the second communication signals to the first communication unit 111. The first communication unit 111 converts the second communication signals into a plurality of the first communication signals. In other words, the first communication unit 111 and the second communication unit 112 can convert the communication protocol of the communication signals.

The first communication unit 111 is a Bluetooth® communication unit. The second communication unit 1112 is a fourth generation of broadband cellular network technology communication unit (4G LTE), a fifth generation of broadband cellular network technology communication unit, a Wi-Fi communication unit, a LoRa communication unit, a Sigfox communication unit, or an NB-IoT communication unit.

The first directional antenna module 12, the second directional antenna module 13, the third directional antenna module 14, and the fourth directional antenna module 15 are electrically connected to the first communication unit 111 of the control module 11.

In the embodiment, the control module 11 is a rectangular circuit module. The first directional antenna module 12, the second directional antenna module 13, the third directional antenna module 14, and the fourth directional antenna module 15 are disposed at four sides of the control module 11. In other words, the first directional antenna module 12 is disposed at a first side of the control module 11. The second directional antenna module 13 is disposed at a second side of the control module 12. The second side of the control module 11 is adjacent to the first side of the control module 11. The third directional antenna module 14 is disposed at a third side of the control module 11. The third side of the control module is opposite to the first side of the control module 11. The fourth directional antenna module 15 is disposed at a fourth side of the control module. The fourth side of the control module 11 is opposite to the second side of the control module 11.

Furthermore, the first directional antenna module 12, the second directional antenna module 13, the third directional antenna module 14, and the fourth directional antenna module 15 are vertically disposed on the circuit board 17. The control module 14 is horizontally disposed on the circuit board 17. In addition, the control module 11 is disposed on one side of the circuit board 17. The first directional antenna module 12, the second directional antenna module 13, the third directional antenna module 14, and the fourth directional antenna module 15 are disposed on another side of the circuit board 17. In other words, the control module 11, the first directional antenna module 12, the second directional antenna module 13, the third directional antenna module 14, and the fourth directional antenna module 15 are disposed on two opposite sides of the circuit board 17.

In other words, a first angle between the first directional antenna module 12 and the control module 11 is 90 degrees. A second angle between the second directional antenna module 13 and the control module 11 is 90 degrees. A third angle between the third directional antenna module 14 and the control module 11 is 90 degrees. A fourth angle between the fourth directional antenna module 15 and the control module 11 is 90 degrees.

The case 10 includes a bottom case unit 101 and a top case unit 102. The top case unit 102 and the bottom case unit 101 have an accommodation space therebetween. The control module 11, the first directional antenna module 12, the second directional antenna module 13, the third directional antenna module 14, and the fourth directional antenna module 15 are disposed in the accommodation space. Four first inner walls 102A and four second inner walls are disposed in the top case unit 102. The four first inner walls 102A and the four second inner walls 102B are disposed on a bottom plate 102T of the top case unit 102. Each of the four second inner walls 102B is arranged between two adjacent first inner walls 102A. In other words, a hollow octagonal cylinder is formed by the four first inner walls 102A and the four second inner walls 102B.

The first directional antenna module 12, the second directional antenna module 13, the third directional antenna module 14, and the fourth directional antenna module 15 are respectively disposed on the four inner walls 102A. In other words, the first directional antenna module 12, the second directional antenna module 13, the third directional antenna module 14, and the fourth directional antenna module 15 are supported and fixed in the case 10 by the circuit board 17 and the four first inner walls 102A.

The bottom case unit 101 is a dish-shaped case, and has a depth. The control module 11 is accommodated in the bottom case unit 101.

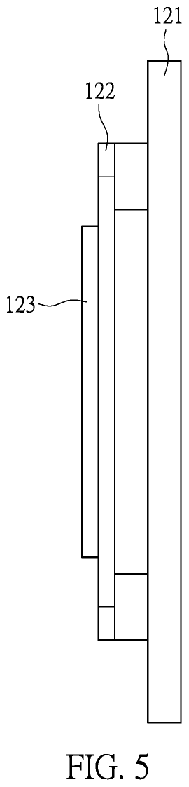

Referring to FIG. 5, FIG. 5 is a schematic view of a first directional antenna of the radar device of the embodiment of the present disclosure.

In the embodiment, the first directional antenna module 12, the second directional antenna module 13, the third directional antenna module 14, and the fourth directional antenna module 15 are two-dimensional antennas.

The following paragraph only takes the first directional antenna module 12 as an example to describe the structure of the directional antenna module. The structure and function of the second directional antenna module 13, the third directional antenna module 14, and the fourth directional antenna module 15 are the same as those of the first directional antenna module 12, and are omitted herefrom.

The first directional antenna module 12 includes a first plate 121, a second plate 122, and an antenna unit 123. The antenna unit 123 is disposed on the second plate 122. The first plate 121 and the second plate 122 have a predetermined distance therebetween. In the embodiment, the first plate 121 of the first directional antenna module 12 is disposed on a first inner wall 102A. The second directional antenna module 13, the third directional antenna module 14 and the fourth directional antenna module 15 are also disposed on the first inner wall 102A by the first plate thereof (not shown). In the embodiment, signal ranges of the first directional antenna module 12, the second directional antenna module 13, the third directional antenna module 14, and the fourth directional antenna module 15 are between 90 degrees and 100 degrees. In other words, the signal ranges of the first directional antenna module 12, the second directional antenna module 13, the third directional antenna module 14, and the fourth directional antenna module 15 are about 90 degrees.

Since the first directional antenna module 12, the second directional antenna module 13, the third directional antenna module 14, and the fourth directional antenna module 15 are vertically arranged on the four sides of the circuit board, a detecting range of each of the directional antenna modules covers a quarter of an area. In addition, a power module 16 provides a driving power to the control module 11 of the radar device 1. The power module 16 is a DC to DC voltage conversion module or an AC to DC voltage conversion module.

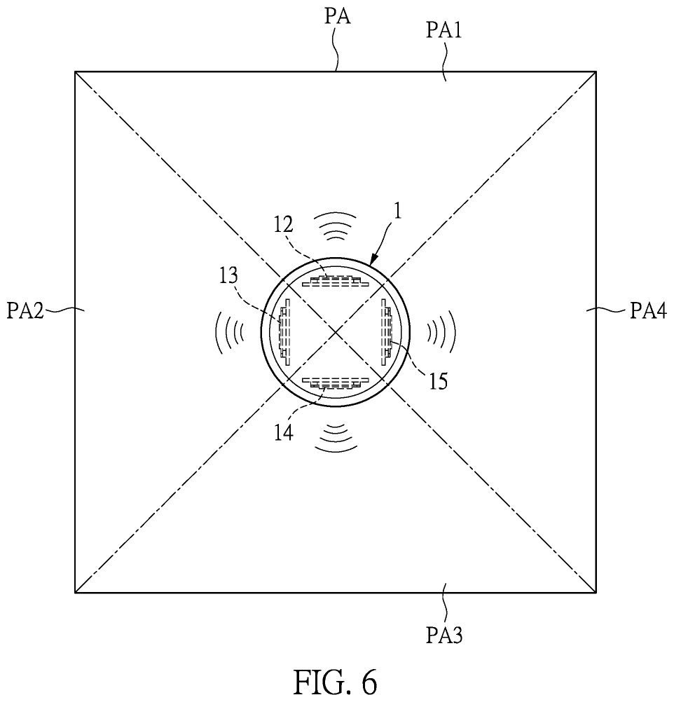

Referring to FIG. 6, FIG. 6 is a schematic view showing the radar device of the present disclosure being disposed in a predetermined area.

When the radar device 1 is disposed in a predetermined area PA, the control unit 110 of the control module 11 transmits a control signal to the first communication unit 111 to sequentially activate the first directional antenna module 12, the second directional antenna module 13, the third directional antenna module 14, and the fourth directional antenna module 15. In the embodiment, the first communication unit 111 sequentially activates the first directional antenna module 12, the second directional antenna module 13, the third directional antenna module 14, and the fourth directional antenna module 15 for respectively transmitting first communication signals to each of the sub-areas PA1-PA4 to detect whether there is someone in the sub-areas PA1-PA4. In other embodiments, the first communication unit 111 may sequentially activate the fourth directional antenna module 15, the third directional antenna module 14, the second directional antenna module 13, and the first directional antenna module. 12. In other words, the first directional antenna module 12, the second directional antenna module 13, the third directional antenna module 14, and the fourth directional antenna module 15 are activated based on a reverse sequence. In addition, an activating sequence of the directional antenna module can be adjusted based on actual requirements.

When the first communication unit 111 sequentially activates the first directional antenna module 12, the second directional antenna module 13, the third directional antenna module 14, and the fourth directional antenna module 15, the first communication signal is transmitted to each of the sub-areas PA1-PA4. When the first communication signal transmitted by the first directional antenna module 12 to the sub-area PA1 is reflected, the third directional antenna module disposed on the opposite side receives the reflected first communication signal of the sub-area PA1. In other words, when the first communication signal transmitted by the second directional antenna module 13 to the sub-area PA2 is reflected, the fourth directional antenna module 15 disposed on the opposite side receives the reflected first communication signal of the sub-area PA4. When the first communication signal transmitted from the third directional antenna module 14 to the sub-area PA3 is reflected, the first directional antenna module 12 disposed on the opposite side receives the reflected first communication signal of the sub-area PA3.

When the first communication signal transmitted by the fourth directional antenna module 15 to the sub-area PA4 is reflected, the second directional antenna module 13 disposed on the opposite side receives the reflected first communication signal of the sub-area PA4.

Therefore, the reflected first communication signal of each of the sub-area PA1-PA4 received by the first directional antenna module 12, the second directional antenna module 13, the third directional antenna module 14, and the fourth directional antenna module 15 are transmitted to the control unit 110 for analyzing.

When a person or a moving object appears in the predetermined area PA, signal strengths and response times of the first communication signals received by the first directional antenna module 12, the second directional antenna module 13, the third directional antenna module 14, or the fourth directional antenna received by the module 15 are changed. The control unit 110 can determine whether the person or the moving object appears in the predetermined area PA through changes of these signal strengths and response times. Furthermore, the control unit 110 can determine the area where the person or the moving object appears based on the difference of the received signals.

In conclusion, the radar device of the present disclosure uses only multiple directional antenna modules to transmit communication signals for detecting whether a person or a moving object is present in a predetermined area so as to control electronic devices and lighting devices.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A radar device comprising:
a control module being disposed on a circuit board, the control module including a first communication unit and a second communication unit, the first communication unit being electrically connected to the second communication unit, the first communication unit transmitting a plurality of first communication signals to the second communication unit, the second communication unit converting the first communication signals into second communication signals;
a first directional antenna module being electrically connected to the first communication unit, the first directional antenna module being disposed at a first side of the control module;
a second directional antenna module being electrically connected to the first communication unit, the second directional antenna module being disposed at a second side of the control module, the second side of the control module being adjacent to the first side of the control module;
a third directional antenna module being electrically connected to the first communication unit, the third directional antenna module being disposed at a third side of the control module, the third side of the control module being opposite to the first side of the control module; and
a fourth directional antenna module being electrically connected to the first communication unit, the fourth directional antenna module being disposed at a fourth side of the control module, the fourth side of the control module being opposite to the second side of the control module;
wherein the first directional antenna module, the second directional antenna module, the third directional antenna module, and the fourth directional antenna module are vertically arranged on the circuit board.

2. The radar device of claim 1, wherein the first communication unit is a Bluetooth® communication unit, the second communication unit is a LoRa communication unit, a Sigfox communication unit, an NB-IoT communication unit, or a Wi-Fi communication unit.

3. The radar device of claim 1, further comprising a case, wherein the control module, the first directional antenna module, the second directional antenna module, the third directional antenna module, and the fourth directional antenna module are disposed in the case.

4. The radar device of claim 3, wherein the case includes a top case unit and a bottom case unit, the top case unit and the bottom case unit have an accommodation space therebetween, the control module, the first directional antenna module, the second directional antenna module, the third directional antenna module, and the fourth directional antenna module are disposed in the accommodation space, four first inner walls are vertically disposed on a bottom side of the top case unit, the first directional antenna module, the second directional antenna module, the third directional antenna module, and the fourth directional antenna module are respectively disposed on the four first inner walls.

5. The radar device of claim 4, wherein the top case unit further includes four second inner walls, and each of the four second inner walls is disposed between two adjacent first inner walls.

6. The radar device of claim 4, wherein the bottom case unit is a dish-shaped case and has a depth, and the control module is accommodated in the bottom case unit.

7. The radar device of claim 1, wherein a power module provides a driving power to the control module, the power module is a DC to DC voltage conversion module or an AC to DC voltage conversion module.

8. The radar device of claim 1, wherein the first directional antenna module, the second directional antenna module, the third directional antenna module, and the fourth directional antenna module are two-dimensional antennas.

9. The radar device of claim 8, wherein the first directional antenna module includes a first plate, a second plate, and an antenna unit, the antenna unit being disposed on the second plate, and the second plate and the first plate having a predetermined distance therebetween.
